(19) United States
(12) Patent Application Publication
(10) Pub. No.: US 2006/0075343 A1
(43) Pub. Date: Apr. 6, 2006

(54) Electronic portal for information storage and retrieval

(76) Inventor: Jim Henry, Folsom, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/232,417

(22) Filed: Sep. 20, 2005

Related U.S. Application Data
(60) Provisional application No. 60/612,218, filed on Sep. 21, 2004.

(51) Int. Cl. G06F 17/00

(52) U.S. Cl. 715/704

(57) ABSTRACT

Systems and methods for communicating picture, video, audio and other informational data relating to a subject, e.g. person, place or thing, to a user by playing a portable viewer at the subject site affiliated with the subject. For example, the subject may be a deceased person, or decedent, and the subject site may be the grave site of the decedent. Alternatively, the subject may by a dwelling for sale and the subject site the property or yard the dwelling is located on. The system has memory module configured to store the video data relating to the subject and configured to attach to a location at the subject site, or be positioned at a remote location. The memory module is configured to interface with a portable playback device and transfer data to the portable playback device to display the video data relating to a subject at the subject site. The memory module may store any number of files including store picture data, audio data, and information relating to the subject.

### CROSS-REFERENCE TO RELATED APPLICATIONS

This application claims priority from U.S. provisional application Ser. No. 60/612,218 filed on Sep. 21, 2004, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to a portable viewing device, and more particularly to a portable viewing device to be used in connection with a memory module having stored data relating to a subject for display of the data at a location affiliated with the subject.

2. Description of Related Art

A variety of different ceremonies and memorials have been used to commemorate the death of a loved one. Indeed, ceremonies and memorials, have become integral for helping the living cope with the death and for commemorating the loved one for future generations. Typically, the grave site is marked by a headstone or other placard. In the case of cremation, ashes are often placed in a sealed urn. For many historically significant individuals, their deaths are sometimes commemorated with a memorial, such as a statue, which is often dedicated years after that individual's death.

While traditional ceremonies and memorials are important, they do have several shortcomings. For instance, visitors have traditionally been required to be physically located at the ceremony or the memorial to view or reflect on the individual. If you are not physically present at the ceremony or the memorial, you cannot share in the achievements and memories associated with the individual. In the case of many ceremonies, the duration is limited to the actual time of the ceremony. Any reflection after the ceremony is limited to the memories of those who actually attended. A further shortcoming is the relatively limited scope of the commemoration. Visitations typically involve a eulogy and memories shared between the participants. Outside the spoken words of the visitors, however, little or no other memories are shared. In the case of traditional memorials, including headstones, urns, statues and the like, memories and messages are usually limited only to a few words etched in stone or on a plaque.

With the development of solid-state memory chips, is has become increasingly available to play back pictures, and movies digitally. With the ability to store large amounts of information in a digital format movies and pictures can be stored and played back at will anywhere any time. It would therefore be advantageous to incorporate such technology incorporate multimedia technology to commemorate the deceased at the gravesite.

Recent developments, such described in U.S. Application Publication No. 2004/0085337A1 to Barrows and No. 2001/0036354A1 to Majors have implemented multimedia playback devices into grave markers for the purpose of viewing pictures and/or movies of the deceased. However, these implementations are exposed to theft and other elements such as wind, rain, and cold/hot temperatures. They are also costly to implement, as such a device would significantly drive the cost of the headstone.

In a similar application, scheduling a viewing and show a house requires considerable coordination between the buyers and sellers, the buyer's agent, seller's agent, all families, and other interested parties. Due to seller's schedules, and the inconvenience that a showing at times would create, there is a considerable burden placed on the seller that could be easily reduced.

While MLS listings adequately describe the features and specific attributes of a property, in most cases, it does not insert the “adjectives” regarding the house, i.e. “big, small, spacious, green, red, roomy, new, etc.” That is left to a one-paragraph summary in the note section. It is a starting place, not necessarily comprehensive enough.

To fill in the attributes of a particular house, the realtor places it on tour, schedules showings, provides walk thru by appointment, and networks with other realtors. In most cases, a prudent buyer's agent will drive-by or visit a home prior to showing to prospective buyer. This would be done so to minimize the intrusion on the seller if the home clearly is not the correct “fit” for the buyer. However, in many cases, there are attributes regarding the house that would either disinterest the buyer or create more interest for the buyer if the buyer were able to view the house themselves.

### BRIEF SUMMARY OF THE INVENTION

The present invention is directed to apparatus and methods for communicating picture, video, audio and other informational data relating to a subject, e.g. person, place or thing, to a user by playing a portable viewer at the subject site affiliated with the subject. For example, the subject may be a deceased person, or decedent, and the subject site may be the grave site of the decedent. Alternatively, the subject may by a real-estate property (building or lot) for sale and the subject site the property or yard the building (dwelling etc.) is located on.

In one aspect of the invention, an apparatus is disclosed for communicating video data relating to a subject to a user at a subject site. The apparatus has a memory module configured to store the video data relating to the subject and configured to attach to a location at the subject site. The memory module is configured to interface with a portable playback device and transfer data to the portable playback device to display the video data relating to a subject at the subject site. The memory module may store any number of files including store picture data, audio data, and information relating to the subject.

In many embodiments, the memory module is configured to restrict data transfer between the portable playback device and the memory module until a password is entered from the portable playback device. Additionally, the memory module may be configured to restrict playback of stored date until a predetermined date, thus acting as a time-capsule that can't be played until a date or event (e.g. subject passing away) occurs. Data transfer may be accomplished via a wired communication port, such as a USB, or serial port, a wireless connection commonly used in the art.

Where the subject is a decedent, and: the memory module may be configured to secure to a headstone. In one embodiment, the memory module is secured inside a cutout section of said headstone wherein the cutout section is configured to lock to the headstone.

Where the subject comprises a building, the memory module may be configured to be secured to a signpost near the building, or the building itself. The memory module is may be loaded with pictures, video and information relating to the building of interest to a potential buyer.

Another aspect is a system for communicating video data relating to a subject to a user at a subject site. The system has a processing device, such as a computer, server, etc. configured to store the video data relating to the subject, and a portable playback device that is able to transfer data from the processing device to display of the video data relating to the subject upon placement of the portable within a predetermined perimeter of the subject site.

The processing device is preferably configured to restrict data transfer between the processing device and the portable playback device until a password is entered from the portable playback device.

In one embodiment, the processing device transfers the data to the memory module via a wireless connection and does not initiate data transfer until placement of the portable playback device within the predetermined perimeter of the subject location. The portable playback device may have a GPS receiver for determining placement of the portable playback device within the predetermined perimeter.

In another embodiment, the portable playback device comprises a base unit configured to receive a portable media player. The portable media player may be any off-the-shelf unit having a display and controls to operate playback of the video data. The base unit preferably has an interface means, such as a USB port and/or a wireless transmitter for remotely transmitting data from the processing device to the portable media player.

Where the subject comprises a decedent, the processing device may be at a kiosk in proximity to the gravesite. The processing device may be configured to transfer data to the portable playback device via a wired port, or a wireless connection such as a WIFI connection.

Where the subject comprises a dwelling or home, the processing unit may be a PC located in the building that wirelessly transfers video data to the portable playback device from a location outside the building.

Another aspect of the invention is a method for communicating video data relating to a subject to a user at a subject site. The method includes the steps of storing the video data relating to the subject in a memory module, attaching the memory module to a location at the subject site, positioning a portable playback device near the subject site, transferring data between the portable playback device and the memory module; and displaying the video data relating to a subject at the subject site.

Another aspect of the invention is a method for communicating video data relating to a subject to a user at a subject site, comprising storing the video data relating to the subject at a first location, transferring the video data from the first location to a portable playback device, placing the portable playback device at a second location within a predetermined perimeter of the subject site, and displaying the video data relating to the subject at the second location.

The method may further include the step of determining the location of the portable playback device with respect to a subject site location, wherein the video data is not transferred from the first location to the portable playback device until the portable playback device is positioned within a predetermined perimeter of the subject site, e.g. a grave marker for viewing at a cemetery, or a home for sale. Otherwise, the data may be preloaded to the portable playback device before taking the portable playback device to the subject site.

In yet another aspect, a time-capsule is disclosed for communicating data relating to an entity (such as a person or home-site) to a user. The time capsule has a memory module for storing time-sensitive data about the entity, an interface for releasing the stored data to the user, and an encryption module for controlling the release of the stored data to occur only after a predetermined date.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a perspective view of an electronic portal system in accordance with the present invention.

FIG. 2 is a rear view of a mount and memory module of the electronic portal system of FIG. 1.

FIG. 3 is a cutout view of the mount and memory module of FIG. 2.

FIG. 4 is a schematic view of the interface between the memory module and portable viewer in accordance with the present invention.

FIG. 5 is a schematic view of an alternative embodiment of the electronic portal system of the present invention.

FIG. 6 is a schematic view of a time capsule in accordance with the present invention.

FIG. 7 is a schematic view of a property viewing system in accordance with the present invention.

FIG. 8 is a schematic view of an alternative property viewing system of the present invention.

FIG. 9 is a portable viewing device in accordance with the present invention.

### DETAILED DESCRIPTION OF THE INVENTION

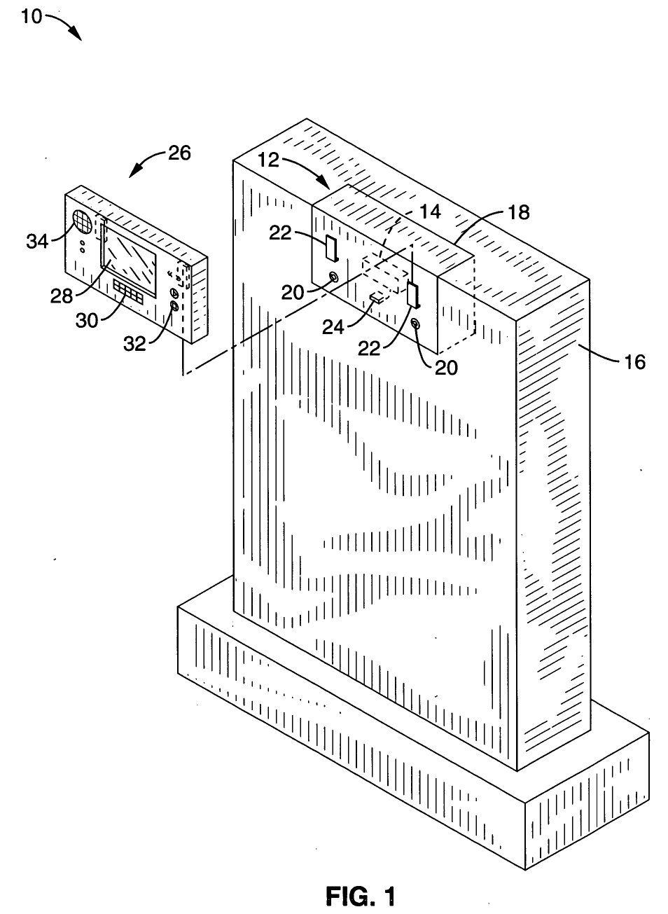

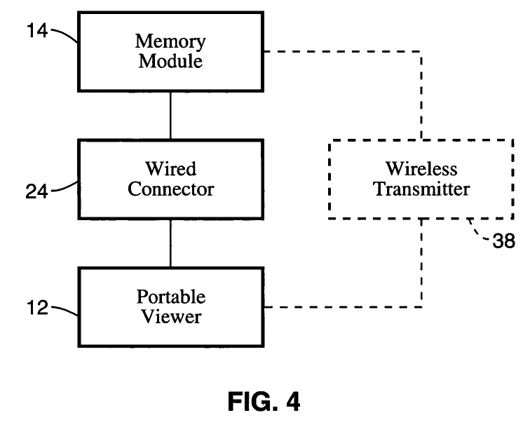

Referring more specifically to the drawings, for illustrative purposes the present invention is embodied in the apparatus generally shown in FIG. 1 through FIG. 9. It will be appreciated that the apparatus may vary as to configuration and as to details of the parts, and that the method may vary as to the specific steps and sequence, without departing from the basic concepts as disclosed herein.

FIG. 1 illustrates an exemplary electronic portal system 10 in accordance with the present invention. A memorial mount 12, comprising a memory module 14, e.g. hard drive, flash, USB, R/W CD, DVD etc. is configured to be mounted, secured, or integrated into a headstone 16. In some configurations, the mount 12 comprises removable cutout section 18 (e.g. granite) that has locking means, e.g. safe-deposit box-type key-locks 20 that secure the section 18 to the headstone 16. Mount 12 may also be an external module that hangs onto and lockably secures into the headstone 16.

The mount 12 is configured to interface with a portable display device 26, such as portable media players commonly available for video and audio playback. The portable display device 26 will generally have a viewing screen 28, speakers for audio playback 34, controls 32. Device 26 may further include a keypad 30 to allow an authorized visitor to enter a password to access encrypted movie and picture or audio files of their loved one.

The portable display device 26 is configured to be paced onto mount 12 via holding clips 22 and connect to the internal memory module 14 via port 24. Port 24 may be a USB, firewire, serial or the like physical connector, or wireless connector using IR, RF or similar transmission means. Once plugged in via port 24, a shell menu may be used to guide the user to the movie, pictures, and audio data of their choosing. Data in the memory module 14 may also be uploaded and updated through port 24 without removal of the mount 12 from the headstone 16.

There is typically little maintenance to the memory module 14 at the headstone 16; as the viewing device 26 typically supplies all power via batteries.

The display devices 26 may be dispensed to visitors on an as-needed basis, thus obviating the need for a display for every headstone having a mount 12.

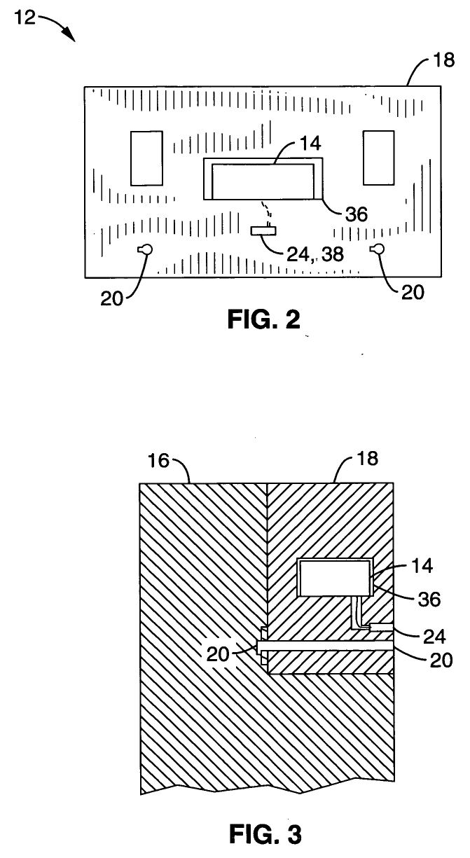

FIG. 2 illustrates a rear view of the mount 12. The removable granite or marble section 18 may be of the same material and grain as the headstone would be removed and a memory module 14 would be inserted into recess 36.

As shown in a cross-section side view of the mount 12 attached to headstone 16 in FIG. 3, access to the memory module 14 from outside the headstone 16 is achieved through port 24. The locking means may comprise a system similar to safe deposit boxes, with a notch and key locks 20 securing the mount 12 to the headstone. Waterproofing and sealing may also be provided between the section 18 and headstone 16 to protect memory module and integrity of data.

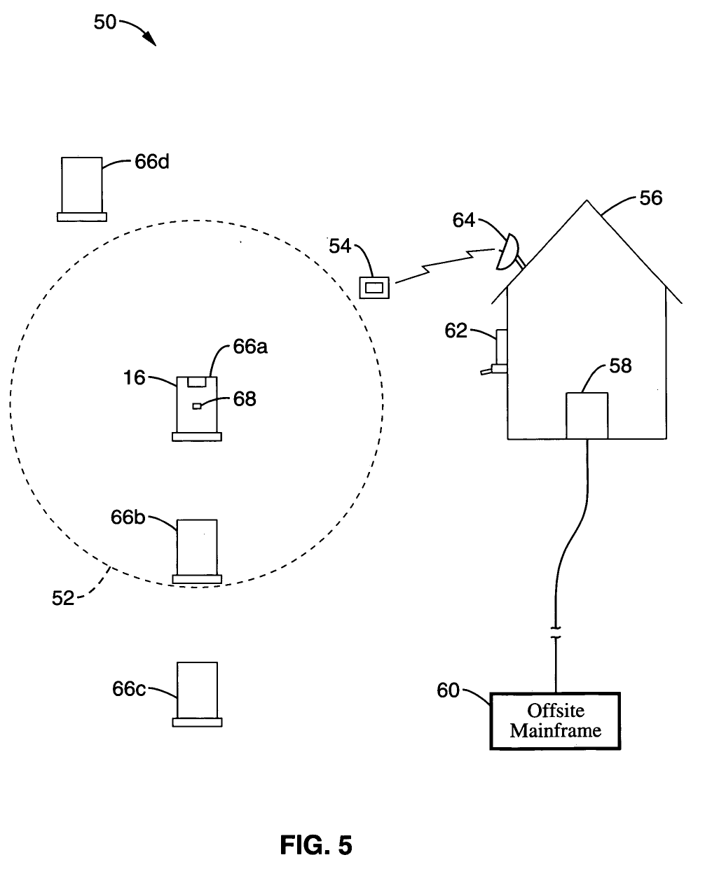

Referring to FIG. 5, the memory module 14 may transmit to the portable viewer 12 via a wireless transmitter as an alternative to, or in combination with, the wired connector 24. The wireless transmitter may use an RF, IR, FM or other signal commonly known in the art.

With the present invention, the sanctity of the burial plot is maintained, and the media module could be included on the headstone is part of an attachment, not part of the actual headstone, and thus not part of the permanent structure and is not disturbing the final resting place. This allows retention of the original headstone without replacement or disturbance of burial site.

The viewer 26 may be programmed with on-screen menus that feature several prompts. A shell showing an initial screen and contact numbers will may be loaded first. The user will be asked for a portal key, or password, and if successfully entered, he/she can go to next screen. If unsuccessful, a customer service number may be displayed so the person can use cell phone to call to get passwords after answering question of a pre-determined criteria.

The viewing/interface software may be configured such that, based on a particular password allotted, only selected groups of files can be accessed. For example: a wife, child, sibling, parent, or friend may all have different passwords that dictate a predetermined level of access to files. An administrator may monitor and change passwords as needed in the future. For further security, the data in the memory module may be encrypted, e.g. with 128 to 256 bit encryption.

Once successfully passing thru the password protection module, the viewer may then provided with the date of passing of the deceased, customizable template backgrounds digital pictures, and the ability to choose from among the following selections: movies by date, event, or person, scrapbook by chronology, family member, or random order, etc.. The files may be viewed with or without sound, e.g. MPEG files or WAV files having an audio component.

The viewer 26 will typically have the capabilities of pause, zoom, pan in, pan out, frame advance, and skip to next chapter, end, and volume up, volume down, commonly available in most multimedia viewing devices. The memory module 14 may also be configured to be “read only” so that data is not erased or copied. There may also be access to record messages.

The memory module 14 may also be configured to retain usage data such as a date tag for each visit, i.e. a guest registry. Thus, authorized viewers may be able to get a log of the time and frequency of visits as well as the identification of the visitors.

For large files, on screen data upload status may be provided along with “time till completion” status updates. Each size file may be noted as well as option to choose to upload and estimated time for upload and full playback.

Prior to installation in the memory module 14, data (pictures, audio, video, etc.) may be compiled by family or loved one for compilation by a computer graphics artist or the like, along with encrypting services if necessary. A maintenance program or upgrade may also be used to add additional movie viewing time. The maintenance program may be hardware or software, and may be available through resellers, funeral directors or funeral homes. The memory module may be configured for memory capacity upgrades to allow for future movie and sound additions. Additionally, storage may be used for storing movies or picture prior to passing. Once the person passes, the data may be encrypted and transferred to the memory module or resting site. The data may also be time-sensitive, i.e. not allow playback until a specified date or event (e.g. death) occurs. The portable viewing units can be rented, leased or purchased by visitors/owners, with password codes available only to purchaser (or leaser) of the viewers.

It is anticipated that there may be many variations as to how and where the data is maintained and uploaded. For example, GPS, WiFi, RF, Satellite and/or other remote technologies may be incorporated to transfer data.

Referring now to FIG. 5, an electronic portal system 50 is illustrated having proximity GPS functionality. In this configuration, the gravestone or other memorial marker 16 does not have or retain any memory for memorial data. Data is made available through a primary portal kiosk 56 that interfaces with a portable viewer 54. The kiosk 56 may have a computer 58, or other processing device, that has a large storage or server capacity to store a number of individual user files at a site, or be networked with a satellite, DSL, or other network link to an off-site host computer 60 that has storage capacity for a number of sites (e.g. in a city or region). Updates, links, downloads can all be accomplished to the kiosk 56 by high-speed download and available for uploads to portable viewers 56 upon visit or overnight. The portable viewer may have a viewing software, such as Windows Media Player, and a memory for storing the downloaded data for current or later viewing.

The system would preferably be highly secure, encrypted, and impenetrable. A person with a portable viewer may download the data files to the portable viewer 54 by being in proximity of the kiosk 56, which would then, upon command, transmit encrypted data to the receiving portable viewer 54 via a wireless transmission means, such as WIFI, etc. Faster downloads may be achieved by plugging in the viewer 54 via port 62 of kiosk 56. Wireless or by port, data would then be activated upon local proximity of the gravesite.

In the wired configuration, the visitor approaches the on-site kiosk 56, plugs portable viewer using USB (or other comms device), and the network computer 58 instantly recognizes a new entrant or user, and queries for password. IF entered correctly, the computer 58 scans for data currency and any updates needed, loads appropriate files (based on password tiers).

Each gravesite 16 has an identifiable GPS position based on its longitudinal and latitudinal location of the earth. Each portable viewer 54 may be configured with a GPS receiver so that when a visitor comes within the proximity (e.g. perimeter 52) of the desired gravesite 16, the unit screen initializes, and a menu shows prompting for a key or password. As long as the person remains within a radius 52 of the gravesite 16, the message will continue to link. Where another gravesite 66 is within the perimeter 52 or resolution of the GPS receiver of the desired site, the unique passwords will allow for further definition of the particular site of interest. This radius or perimeter 52 can be any determined distance or even turned off. Various options are available for viewing on site or download for viewing at a future date or time (in the car or home for instance). Integrated GPS software will link with the portable viewer 54 to activate on-screen options.

It is appreciated that a number of different remote sensing means other than GPS may be used to trigger the initialization of the viewer software. For example, each headstone 16 may have a small beacon 68 (e.g. FM, RF or IR transmitter) that transmits a signal to initialize the portable viewer 54 once the visitor enters perimeter 52. Alternatively, the perimeter/vicinity functionality may be disabled or forgone in lieu of manual initialization by the user upon entering the site.

Alternatively, system 50 may be configured to allow real-time viewing from the portable viewer 54 by downloading from the primary portal or kiosk 56 using audio and visual streaming technology. Upload may be done via WiFi, wireless network, cellular, FTP, blackberry, blueberry, RF, IR, High Speed-High Frequency RF, or DSSS. In this configuration, the portable viewer 54 would serve as a read-only access point via a wireless network connection (e.g. wireless transmitter 64) to the computer or server 58. Each portable viewer 54 may have an unique ID number that allows for specific privileges within the network, with the main menu limiting explorer-level access.

For example, WiFi may be used as the secure link between the network computer 58 and the portable viewer 54. File sharing privileges allowed for via password may be implemented to automate the link. When the user enters the gravesite perimeter 52, the GPS activates a shell program, and application will initialize the automated upload of information to the portable viewer 54, using date and file size comparison. The portable viewer 54 software may be configured to determine if a file has been previously uploaded and if there is an updated file available for viewing. If a user with incomplete files or in need of updating is recognized, the update-specific password will contain all data sufficient to allow for specific file privileges and specific access to designated areas and files only within the site. Thus, data transfer may be implemented via a transparent and seamless-automated process.

Programmer-level access may be maintained at the offsite location 60 via high speed internet or downloading capability. In this configuration, the portable viewer 54 is a network within the computer 58; and the computer 58 is a network within offsite location 60.

The portable viewer 54 is configured for automated activation of the menu and application viewer programs. WiFi access cards and ID numbers may be used so that multiple users may simultaneously use the network and passwords will provide access to “files” privileges. Essentially, the grounds of the cemetery are access points to a series of “read-only” data upload viewers. Frequency saturation and differentiation are minimized by the password protected sharing properties of the network. In this configuration, one would not have the ability to retrieve other's files, and vice versa. The GPS location and entrance to the perimeter 52 may serve the function of logging onto the computer network 58 and downloading information all within a shell program and a series of “macro-like” functions that are transparent to the viewer. All the person will do on the screen is turn the fully-charged portable viewer 54 “on” when they arrive to the cemetery, and walk toward the gravesite 16. Thereafter, unit initializes, asks for password, and after the user enters the correct number sequence, the portable viewer 54 begins to receive data.

The process is seamless to the user as files build. The first file to load may be user or provider selected. This could include smallest, oldest, newest, pictures first, then movie, then sound (smallest to largest) or other user/provider defined options

Depending on the file size, and speed, an estimated time to download is displayed. Further information such as whether there are updates available, and user selected viewing options may also be displayed. Data transfer may proceed like a JPEG file in which the file builds partially. When the smallest file is received (depending on speed of data transfer), the file can be made available for viewing. Thus, the viewer 54 may display a file while additional files are loading.

The portable viewer 54 is preferably waterproof, durable and rechargeable and able sustain charge for several hours. Since viewing data is stored remotely, permanent loss of data is not possible and in any event, the portable viewer 54 can be replaced and data can be re-uploaded.

In the event that a wireless connection is down or slow, the system may also have wired port 62, e.g. a USB or the like, hub could be enabled at the kiosk 56 for quicker data verification and upload.

In all wired and wireless configurations, there may further be the option to “log off” current user and change user to view different files with a different password coding sequence. By doing so, additional uploads may be necessary, but can only be accessed by the password-correct user. Files may be resident on the portable viewer 54, but they can be viewed only with the appropriate password clearances.

Periodically, file data in the portable viewer 54 and will be compared for antiquity and completeness. Based on the volume of available viewing data, files may be toggled to be purged by the viewer. A viewer can identified previously viewed files and when they were viewed. Additional access may include options for “my favorites” to quickly access favorite files. They may be given status of memory available and provided recommended options. In no event is data lost, it will always reside in the PP and on the EPI,c network. If different files are desired, a partial or full data purge is available, and the user can decide those files to be included in the subsequent data upload. This can be done wired or wireless.

Additionally, the system 50 shown in FIG. 5 may be used in vault-style crypt or similar resting places. If the GPS will not activate indoors, an RF receiver may be implemented instead. Once the viewer comes within RF range, instead of GPS, it could initiate the upload sequence.

Vault configurations may include a computer in the large bank of crypts to allow for download at close proximity to the viewer 54.

Headphones (plug-in or encrypted/secure wireless headphones) may also be used for viewers who would like privacy or use in enclosed areas. Multiple portable viewers 54 may be tuned in and multiple viewers may listen by use of a splitter. Broadcast may also be commenced to multiple portable viewers in the immediate vicinity. If viewer 54 is wireless, multiple users can view at same time with different or same viewing privileges. Viewer 54 can be set for all devices to view the same file or document, or can be set for different level access during same visit based on password access.

The electronic portal system 10 of FIG. 1 is envisioned to be the more affordable initially due to the memory stored in each site. However, upgrade and adding additional content may be cumbersome as it would need to be done on-site.

The system 50 of FIG. 5 would be more costly initially due to the wireless and/or GPS modules, but the primary server 58, via access port 62, would be easier to update and would maintain vastly larger blocks of information.

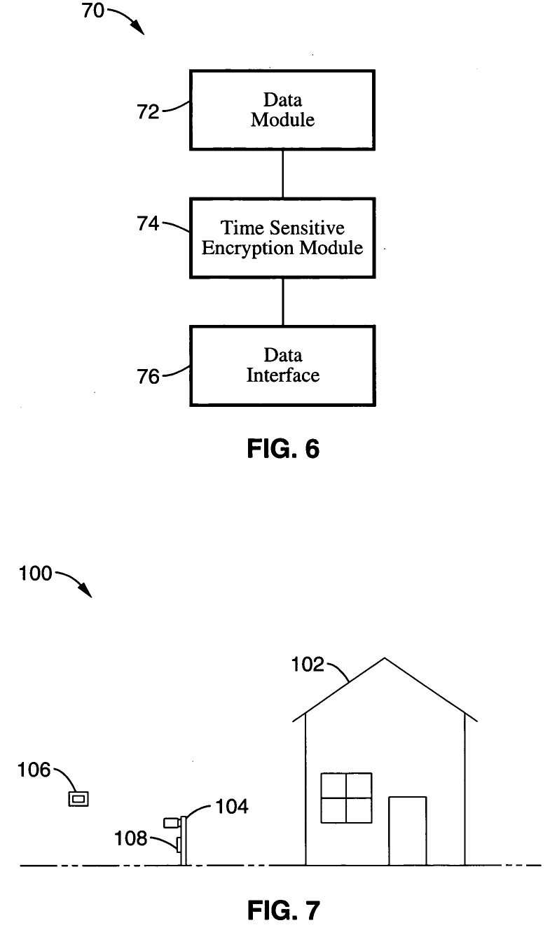

Referring now to FIG. 6, the present invention may also include a time capsule 70. The time capsule 70 includes a time-sensitive message incorporated in a data module 72 that will be released only after a certain date. Access to the data via a data interface 76 is restricted via a time-sensitive encryption module that only allows that data to be communicated until a specified date occurs, or a correct password is entered for editing.

For example, the data may only be allowed to be played until after a specified date (e.g. Dec. 31, 2022), or death of a particular individual. A pre-recorded message may then be access and viewed. This could be used as advice given to a 10 year old eight years in the future when he/she turned 18.

A password may be identified in a will, along with access codes. On the appointed date, the person could then be able to view the information. Alternatively, the time capsule may act as or supplement a will itself.

The person of rest would be the owner of the information and can change, modify or remove any or all information included in the capsule 70. This movement can be before or after passing. Instructions could be left in wills that request the insertion or deletion of certain memory modules. If so designated, it can be stipulated that a third party or family members without legal consent of the deceased can make no change or modifications to these memory modules.

Referring to FIG. 7, the above concepts may be incorporated in a property viewing system 100. In much the same way as a visitor obtaining information about a decedent at a gravesite, a potential buyer may also be able to achieve information about a home 102, without actually having to enter the property, via a portable viewer 106.

As shown in FIG. 7, system 100 includes a memory module 108 mounted to a real estate sign post 104 in the front yard. Memory module 108 may be a hard drive, flash or other memory device would provide storage for picture, movie, audio and other data files similar to that of system 10 in FIG. 1. The memory module 108 would also include connection means (such as a USB port, to allow portable viewer 106 to be download information about the residence. Once downloaded, the prospective buyer would be able to preview, and view a property digitally in movie or picture form prior to, during, or after a scheduled viewing.

The information contained in the memory module would typically include that which is usually found on the flier holder in front of the house (this way if there is no flier, there is less possibility of a lost sale). In addition, the module may contain pictures of the backyard, front yard, kitchen, garage, and other attributes could be potentially interesting to the buyer. Additionally, it could be made into movie form to make the viewing more interesting and marketable. Additional access to MLS information could be downloaded for review at the site. While clients are house hunting, there typically is a huge volume of information buyers are trying to remember, assimilate and prioritize. If all the information such as schools, parks, square footage, kitchen amenities, floor plan, number of bedrooms, square footage of master and other bedrooms, etc, were available all in one device along with agent contact numbers and pictures of the yard, etc, it would be very powerful marketing tool for the seller to remind the buyer of the particular uniqueness of the property. Additionally, if a spouse were visiting from out of town and went to visit a few properties prior to the other spouse joining for “house hunting”, the property viewing system 100 would serve as a useful reminder for all the attributes when reviewing and describing previously visited properties.

Viewer 106 may also be configured to transfer files once home into easily used format. The viewer would have the ability to interface with USB with port 136 to be viewed at home or in easily transferable/printable format (PDF/etc).

A password, or other protection means such as encryption, may also be incorporated to restrict access if desired by the seller. Password and encryption may also serve to deter theft of the memory module, as it would be useless to anyone who would wish to steal it.

For those in more vandalism prone areas or adverse to theft the memory module could be installed thru the wall in the garage (not shown). Access to the memory module may be attained through a USB or like port. The residual small (⅜″) hole could be patched upon removal with no difficulty and no damage. For realtors, it could also be placed in the lock box at the site.

128 bit encryption and thru licensing, as with MLS, may be applied to the information so that it is only available to buyers engaged with an agent. The buyers will be provided a password, and only by use of the password will the information be passed thru the viewer 106. This would minimize unauthorized access to pictures or information regarding the property. The passwords will be assigned to the seller agent and not known to the buyer.

The passwords may also come with an assigned automatic termination date. By doing so, as a property is sold, the password will be deactivated and also terminate at a pre determined time. At that time it will be renewed or deactivated.

In an alternative embodiment, the viewer 106 could be initially downloaded with prospective properties for viewing at the realtor's office or downloaded via the internet. The download, based on MLS criteria for, size, sq ft, bedrooms, price, etc. could be specified and downloaded to meet the buyers individual purchase criteria. They can be reviewed in the buyer's agent office if desired. Buyers (with or without agent) can drive to a list of different properties with the portable viewer 106.

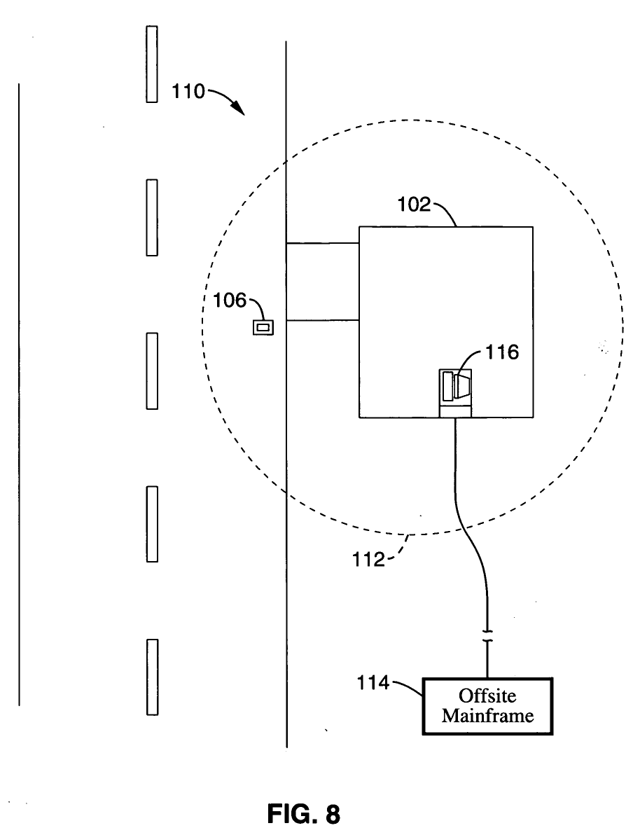

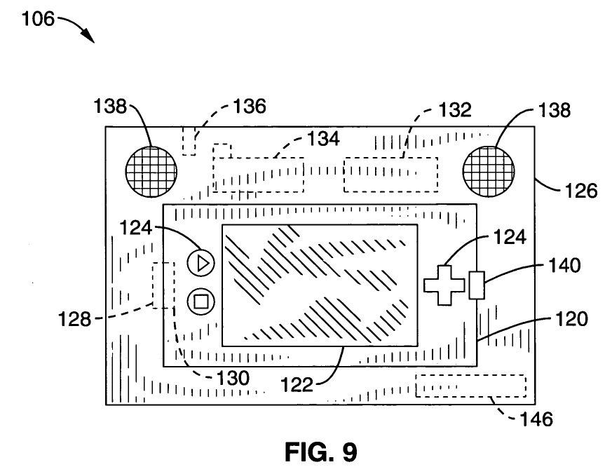

Referring to FIG. 8, property viewing system 110 may be configured to automatically enable upon entry within perimeter 112 of home 102. The portable viewer 106 may have a GPS receiver (shown in more detail in FIG. 9) to determine when the viewer has entered within a predetermined range of the home site. The perimeter 112 range may be specified at any distance and updated at any time.

System 110 includes a computer 116 at the seller's property providing the functions essentially that of the primary server 58 of the system 50 of FIG. 5. Computer 116 would preferably be configured with memory to hold the desired files, and would have wireless communication means to remotely download information to view 106 upon entering perimeter 112. Information may be downloaded from an offsite mainframe 114 to the computer 116 via the internet. Alternatively, the offsite mainframe 114 may communicate and download to viewer 106 directly via a wireless internet connection.

Download and updates, if not available on line, can also be provided by personal visit of seller agent via USB connection at the subject property to computer 116. Viewer 106, in an administrative/management mode, can be plugged into computer 116 or storage module 108 for easy-executed automated menu-driven on-site file updates to read-only files.

Data may be loaded on the computer 116 prior to the listing. Prior to installation, the realtor may send, e.g. via email or other similar delivery means, relevant pictures of the home and information to be included in the property. The completed file may then be returned via email to the seller's email address. An interface module may then be downloaded to the interface device. The interface device, thru USB or other hub would then load the drivers, password and necessary information into the on-site computer 116 to be delivered to the sellers address.

FIG. 9 illustrates a viewer 106 in accordance with the present invention. Viewer 106 may be used on either of the property viewing systems shown in FIGS. 7 and 8, or in the electronic portal systems of FIGS. 1-5.

Viewer 106 includes a base 126 preferably configured to be compatible with a portable media device 120 such as Creative: Zen®, Windows Media Player, or the like, having controls 124 and display 122. Alternatively the base 126 may be integrated with the display and control functionality of the media player.

The portable media device 120 plugs into base 126 via interface port 128, and corresponding port 130 of device 120, e.g. a USB or similar connector. Base 126 may also include power source 146 such as a battery pack, GPS proximity locating device 132, wireless antenna and circuitry 134 for communicating to home computer 116 or offsite mainframe 114, and USB port 136, boot chip and associated electronics and firmware to transfer files from PC, wireless network or USB Storage Device to the viewer. Speakers 138 may also be included for playback of audio files.

The base unit 138 may be configured to run on standard AA batteries or rechargeable NmH batteries. If alkaline batteries are used, it would be possible to replace the batteries in the field and minimize any possible down-time for user.

The data available to the viewer may have chapters (i.e.: outside and back yard, kitchen, bedrooms, baths, schools, brief description, Thomas Guide location, floor plan, square footage, location to fire department, shopping, seller agent contact info, etc.) If a chapter runs long, player 122 typically have controls 124 to fast forward, reverse, slow fast, slow reverse, still, pan, and zoom.

Templates may be provided to maintain quality and provide a professional viewing experience. Sellers would then be able to choose from a menu of viewing templates that best characterize their home. (e.g. modern, classical, country, old-world, southwestern, etc.) to maintain a quality viewing experience. All guests and visitors are greeted with quality templates, consistent viewing experience within specified viewing parameters, and program files will be customizable to allow for upgrade or additional features. The system may be configured to allow the upgrade options such as pictures only, pictures with transitions, pictures, transitions and audio, pictures, audio and movies, etc. Because each level of graphics requires more memory and processor capacity, they generally take more time to produce. As such, the client will be given options to choose from the modest/basic package to feature-enhanced premium packages as described in provisional patent package.

Base 126 is configured to receive the portable player 122 and lock it in place with latch 140. The user can “disconnect” the portable player 122 after the data content has been captured and downloaded to the portable player 122 and use without the base 126. Once the download is complete, the user can view data or movies at their convenience. Thus the base 126 could be used in a manner similar to a port replicator for a PC. The player can be taken home as well and viewed/printed from the interface kit loaded with firmware to print options directly from base 126 as downloaded to viewer #122. An interface kit in the base 126 is envisioned to include USB Embedded host controllers (Similar to those manufactured by Cypress Semiconductors DRD SL811HS) that allows for host controllers to switch back and forth with peripherals. The device will direct interface with PC, wireless transfer files with PC, and direct connect with USB mass storage device. Firmware will also include password procedures and file encryption.

It is appreciated that the memory module 108 of FIG. 7 may be configured to interface directly with media player 122 (e.g. through port 136 of base 126 to offer a limited portion, or all, of the stored information to a prospective buyer. In this configuration, the media player 122 would plug directly into the memory module interface, and download information via a self-executable file stored in the memory module. Some or all of the information may be password protected such that the prospective buyer without prior approval only obtains limited information that would generally be found on an informational flyer. Upon further inquiry, the prospective buyer may contact an agent to obtain passwords for additional detailed information.

Aside from the convenience to the buyer, the impact to the seller is also minimized. With the viewer of the present invention, a buyer or agent of buyer could drive up to the property, initialize the player and play the attributes of the house they are parked right in front of. The buyer may gain insight to aspects the property not available in a flyer or view from the exterior that may interest or disinterest the buyer. Thus, the buyer may inquire further where he/she otherwise would not have. In addition, the additional information may preclude a buyer from imposing an in-person showing on the seller, and thus save those types of intrusions on buyers who are truly interested.

The system of the present invention also serves to organize and memorialize a prospective buyer's home search. A day's, week's, or month's worth of showings may be saved on the buyer's personal viewer for later retrieval, obviating the need for stacks of notes and fliers that accompany typical viewings. Quite often the attributes and amenities of one house versus another are confused. With the present invention, if there was a question, quite probably it could be easily answered by the data contained or reminded by the secure viewer, which may save the seller the imposition of yet again another viewing to see the house. Additionally, updates to pricing and features can easily be made by updating transferred files. Updates such as offer pending and sold banners can readily be added to the data files.

It is also appreciated that the viewing devices 26 (shown in FIG. 1), 106 (shown in FIG. 7) or 126 (shown in FIG. 9) may comprise a variety of display configurations. For example, devices 26, 106 and 126 may comprise a LCD, plasma, projection, or other display means known in the art. Alternatively, devices 26, 106 and 126 may also project a 2-D or 3-D image (i.e. holographic image) of the subject matter desired to be shown.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An apparatus for communicating video data relating to a subject to a user at a subject site, comprising:
a memory module configured to store the video data relating to the subject;
the memory module configured to attach to a location at the subject site;
the memory module configured to interface with a portable playback device and transfer data between the portable playback device and the memory module to display the video data relating to a subject at the subject site.

2. An apparatus as recited in claim 1, wherein the memory module is further configured to store picture data, audio data, and information relating to the subject.

3. An apparatus as recited in claim 1, wherein the memory module is configured to restrict data transfer between the portable playback device and the memory module until a password is entered from the portable playback device.

4. An apparatus as recited in claim 1, wherein the memory module is configured to restrict playback of the stored data until a predetermined date elapses.

5. An apparatus as recited in claim 3, wherein the memory module is configured to transfer data via a wired communication port.

6. An apparatus as recited in claim 3, wherein the memory module is configured to transfer the data to the portable playback device via a wireless connection.

7. An apparatus as recited in claim 1:
wherein the subject comprises a decedent; and
wherein the subject site comprises a grave site of the decedent.

8. An apparatus as recited in claim 7, wherein the memory module is configured to secure to a headstone.

9. An apparatus as recited in claim 8:
wherein the memory module is configured to be secured inside a cutout section of said headstone; and
wherein said cutout section is configured to lock to the headstone.

10. An apparatus as recited in claim 1:
wherein the subject comprises a building; and
wherein the subject site comprises a location on the property of the building.

11. An apparatus as recited in claim 10, wherein the memory module is configured to be secured to a signpost near the building.

12. An apparatus as recited in claim 10, wherein the memory module is configured to be secured to the building.

13. An apparatus as recited in claim 10, wherein the memory module is configured to store pictures, video and information relating to the building.

14. A system for communicating video data relating to a subject to a user at a subject site, comprising:
a processing device configured to store the video data relating to the subject; and
a portable playback device configured to transfer data from the processing device;
wherein the portable playback device is configured to allow display of the video data relating to the subject upon placement of the portable within a predetermined perimeter of the subject site.

15. A system as recited in claim 14, wherein the processing device is configured to store picture data, audio data, and information relating to the subject.

16. A system as recited in claim 14, wherein the processing device is configured to restrict data transfer between the processing device and the portable playback device until a password is entered from the portable playback device.

17. A system as recited in claim 16, wherein the processing device is configured to transfer data via a wired communication port.

18. A system as recited in claim 18:
wherein the processing device is configured to transfer the data to the memory module via a wireless connection; and
wherein the portable playback device is configured to initiate data transfer upon placement of the portable playback device within the predetermined perimeter of the subject location.

19. A system as recited in claim 18, wherein the portable playback device comprises a GPS receiver for determining placement of the portable playback device within the predetermined perimeter.

20. A system as recited in claim 14:
wherein the portable playback device comprises a base unit configured to receive a portable media player; and
wherein the portable media player comprises a display and controls to operate playback of the video data.

21. A system as recited in claim 20, wherein the base comprises a wireless transmitter for remotely transmitting data from the processing device to the portable media player.

22. A system as recited in claim 14:
wherein the subject comprises a decedent; and
wherein the subject site comprises a grave site of the decedent.

23. A system as recited in claim 22, wherein the processing device is at a kiosk in proximity to the gravesite.

24. A system as recited in claim 23, wherein the processing device is configured to transfer data to the portable playback device via a WIFI connection.

25. A system as recited in claim 14:
wherein the subject comprises a building; and
wherein the subject site comprises a location on the property of the building.

26. A system as recited in claim 25:
wherein the processing unit is located in the building; and
wherein the processor is configured to wirelessly transfer video data to the portable playback device from a location outside the building.

27-38. (canceled)

39. A time-capsule for communicating data relating to an entity to a user, comprising:
a memory module for storing time-sensitive data about the entity;
an interface for releasing the stored data to the user; and
an encryption module for controlling the release of the stored data to occur only after a predetermined date.

40. A time capsule as recited in claim 39:
wherein the stored time-sensitive data relates to an individual; and
wherein the time capsule is configured to be secured to a burial marker for playback at a burial site after the predetermined date.
